(19) United States
(12) Patent Application Publication
(10) Pub. No.: US 2018/0213979 A1
(43) Pub. Date: Aug. 2, 2018

(54) Mixing Bowl Having a Suction Cup

(71) Applicant: keeeper GmbH, Stemwede (DE)

(72) Inventors: Alex Dumler, Hamburg (DE); Florian M. Witt, Wentorf (DE); Johanna Königsberger, Hamburg (DE); Matthias Hecker, Hamburg (DE); Thorsten Plate, Hamburg (DE); Andrew Ferrier, Ottawa (CA)

(21) Appl. No.: 15/885,924

(22) Filed: Feb. 1, 2018

(30) Foreign Application Priority Data
Feb. 2, 2017 (EP) 17 154 468.7

(51) Int. Cl. A47J 43/07; A47G 29/093

(52) U.S. Cl. CPC A47J 43/0727; A47G 29/093

(57) ABSTRACT

A plastic mixing bowl has a bowl body with a bottom side and an elastic annular seal that is provided with a peripheral region that in radial direction of the annular seal is positioned inwardly and is connected air-tightly to the bottom side of the bowl body. The annular seal has a lip extending from the peripheral region at least partially in radial direction outwardly. The lip is moveable into various positions and has a lower side forming a placing face by which the mixing bowl is supported on a setup surface. Annular seal and bottom side of the bowl body form together a suction cup that delimits a cavity varying in size depending on a position of the lip. The annular seal is repositionable from a position of use to a non-use position and in the non-use position bears flat against an exterior surface of the bowl body.

### BACKGROUND OF THE INVENTION

The present invention relates to a mixing bowl made from a plastics material, having a setup element of elastic material that on the base side is connected to the mixing bowl. The setup element provides a placing face and is configured as an encircling annular seal. The peripheral region of the annular seal points in the radial direction inward and is connected to the bottom side of the mixing bowl air-tightly, wherein a lip of the annular seal that in a load-dependent manner is movable between various positions extends from the inwardly pointing peripheral region at least partially in a radial direction toward the outside, the lower side of the movable lip in portions forming the placing face by way of which the mixing bowl in at least one position of the movable lip stands on a setup surface. The annular seal conjointly with the bottom side of the mixing bowl forms a suction cup which delimits a cavity that varies in size depending on the position of the movable lip.

A mixing bowl is known, for example, from document DE 20 2009 009 198 U1. In order for the mixing bowl to be able to be set up on a worktop so as to be better secured against slippage it is proposed that the seal that encircles the base side in an annular manner is provided in each case with one lip on the internal and the external lower periphery of the seal, the lips therebetween delimiting a cavity in which a vacuum can be generated on a smooth setup surface. The mixing bowl is pushed onto the setup surface by way of the vacuum in the cavity and can no longer be displaced that easily when mixing.

Since the cavity has only a small volume, the vacuum that can be generated therewith is comparatively minor. Moreover, the lips have only a thin material thickness such that the lips fail already when slightly damaged and no longer reliably seal the cavity in the case of likewise only minor irregularities in the setup surface.

Furthermore, a bowl of the generic type which can be used as dining crockery for babies is known. A suction cup by way of which the bowl can be fixedly connected to the setup surface such that a baby can scoop the meal more easily from the bowl without having to firmly hold the bowl or without tipping the bowl is located on the bottom side of the bowl. The suction cup that is produced from silicone can be held in an adhesive manner on the setup surface by way of a vacuum. The vacuum is cancelled when air is admitted into the cavity below the suction cup, and the bowl is freely movable again. However, the suction cup is an impediment when the bowl is not intended to adhere to a setup surface, for example when the bowl is to be freely movable or stored.

It is the object of the present invention to achieve a mixing bowl having a suction cup, in which the suction cup is not an impediment when the bowl is to be moved or stored.

### SUMMARY OF THE INVENTION

This object is achieved for a mixing bowl of the generic type in that the annular seal is repositionable from a position of use to a non-use position, and the annular seal in the non-use position bears flat against an exterior surface of the bowl body of the mixing bowl.

On account of the combination of the bottom side of the mixing bowl and the annular seal so as to form a suction cup, a much larger cavity in the suction cup can be delimited than is the case in the prior art. Higher holding forces can be generated due to the larger cavity. By pressing the mixing bowl downward, those regions of the movable lip that in the radial direction are external pivot upward while the cavity that herein is delimited by the annular seal conjointly with the bottom side of the mixing bowl is decreased in size and excess air from the cavity escapes between the movable lip and the setup surface to the outside until a pressure value that is almost identical has been attained between the external ambient pressure and the air pressure in the cavity that has been reduced in size in relation to the normal position. That region of the lower side of the movable lip that in portions forms a placing face thus bears on the surface of a setup surface such that air cannot enter the cavity from the outside, and the movable lip seals the cavity in relation to the outside in terms of atmospheric gas that would otherwise potentially enter the cavity. To this end, the surface of the lower side of the movable lip is designed in a correspondingly smooth manner, and the elastic material has sufficient softness so as to be able to adapt to the structure of the surface of the setup surface.

Depending on how far the mixing bowl is pushed down onto the setup surface, the cavity is decreased more or less in size, and a larger or smaller quantity of air is evacuated herein from the cavity. Depending on the quantity of air that flows out of the cavity, a lower or higher contact pressure by way of which the mixing bowl is pressed onto the setup surface results. The pressure with which the mixing bowl is pressed onto the setup surface by way of the suction cup is also dependent on how hard the mixing bowl is pressed onto the setup surface beforehand. Depending on the length of the stroke movement, the mixing bowl by way of a higher or lower contact pressure can thus be set to a desired holding force by way of which the mixing bowl is held on the setup surface. The movable lip thus enables the holding force, by way of which the mixing bowl is held on the setup surface, to be varied.

The elastic material of the movable lip in the load-dependent pivoting movement builds up restoring forces on account of the material deformation that arises in the pivoting movement. If the mixing bowl thereafter is fully or partially de-stressed, the restoring forces that have built up in the elastic material return the movable lip at least almost back to the initial position of the lip. Since the cavity herein is enlarged again, but no fresh air can flow into the cavity on account of an air-tight bearing of the lower side of the lip on the setup surface, a vacuum is formed herein in the cavity. On account of the vacuum that is produced in the manner described in the cavity, the mixing container is pushed onto the setup surface by the external ambient pressure, on account of which the reliability and strength in terms of stability of the mixing container is significantly enhanced.

A larger part of the setup surface can be covered by the suction cup due to the annular seal which extends at least partially in a radial direction toward the outside. The volume of the cavity is enlarged on account thereof. On account of an oblique position of the movable lip in the initial position in relation to the plane of the setup surface, those regions of the movable lip that in the radial direction are external can readily pivot upward in the case of a load acting thereon. Therefore, no high force has to be applied in order for the mixing bowl to be pushed onto the setup surface and for gas that is located in the cavity to be evacuated from the latter.

The annular seal is repositionable from a use position to a non-use position. The mixing bowl is often also preferably held obliquely by a user, or it is desirable for the user to be able to easily slide the mixing bowl back and forth on the setup surface. The movable lip can be an impediment in such a case, and it is advantageous in this instance for the movable lip to be repositionable from the normal use position of the lip to a non-use position. The movable lip in the non-use position is not in contact with the setup surface when the mixing bowl is placed onto the setup surface. The annular seal is advantageously held in the non-use position by the inherent tension of the elastic material. This is possible for example, in that the free end of the movable lip is pivoted upward beyond a dead center. The elastic material of the movable lip is imparted the maximal elongation thereof in the region of the dead center. Having overcome the dead center, the movable lip springs upward by way of the restoring forces stored in the elastic material because the elastic material is again relaxed herein. When the movable lip is in the non-use position, the mixing bowl can stand on the setup surface by way of the support element.

The annular seal in the non-use position bears flat against the exterior surface of the bowl body of the mixing bowl. The annular seal in this position requires only very little space in the vicinity of the mixing bowl and is no impediment to the easy handling of the mixing bowl. The mixing bowl can also be gripped without risk of slippage in the region of the annular seal because of the elastic material thereof.

According to one design embodiment of the invention, the movable lip is connected to the mixing bowl at the external periphery of the bottom side. When the internal peripheral region of the movable lip is placed as far to the outside as possible, the cavity can be of a correspondingly large size. In that the bottom side of the mixing bowl is supported across an area that is as large as possible, a highly tilt-proof footing of the mixing bowl on the setup surface also results.

According to one design embodiment of the invention, the movable lip is configured as a flat annular seal. The movable lip can be readily and uniformly deformed when a contact pressure is exerted on the former as a flat annular seal. Said flat annular seal nevertheless has sufficient strength in order to hold the mixing bowl in a set-up position even when a vacuum is set in the cavity.

According to one design embodiment of the invention, a tension lug is molded to the movable lip. The tension lug can be readily gripped and be raised from the setup surface in order for the movable lip in this region to be raised so far that air can flow into the cavity from the outside such that the vacuum state in the cavity is cancelled. The tension lug preferably projects laterally and/or upwardly beyond the surrounding external contour of the movable lip. The tension lug is thus not located directly in that region in which the external atmospheric pressure urges the movable lip onto the surface of the setup surface.

According to one design embodiment of the invention, a support element which defines a maximum lowering height of the mixing bowl in relation to the movable lip is configured on the bottom side of the mixing bowl. In one preferred embodiment, the support element is disposed within the cavity. Said support element extends in the vertical direction across part of the height of the cavity. The support element can be configured from a plurality of individual and mutually separate support feet, or as an encircling ring which projects beyond the neighboring surface of the bottom side of the mixing bowl. The support element serves the purpose of ensuring that the movable lip is not excessively stretched to the extent that the lip can no longer reliably seal the cavity in relation to the outside. Moreover, the support element delimits the stroke path of the movable lip and thus the air volume which can escape from the cavity when the mixing bowl is pressed onto the setup surface. On account thereof, the holding force of the suction cup that results from the vacuum in the cavity is limited to a reasonable value.

It is to be explicitly pointed out that, to the extent that no technically inhibiting obstacles exist, each of the design embodiments of the invention that has been described above can be combined with the subject matter of the main claim individually but also in any arbitrary combination with another design embodiment.

Further modifications and design embodiments of the invention can be derived from the description of the subject matter hereunder and from the drawings.

### BRIEF DESCRIPTION OF THE DRAWINGS

The invention is now to be described in more detail by means of an exemplary embodiment.

FIG. 1 shows a view of a mixing bowl having an annular seal from obliquely below.

FIG. 2 shows a view of the mixing bowl shown in FIG. 1 on a setup surface.

FIG. 3 shows a view of the mixing bowl having the annular seal, in a non-use position.

FIG. 4 shows a sectional view of a mixing bowl having the annular seal, in a position of use.

FIG. 5 shows the mixing bowl having the annular seal shown in FIG. 4 in a non-use position.

### DESCRIPTION OF PREFERRED EMBODIMENTS

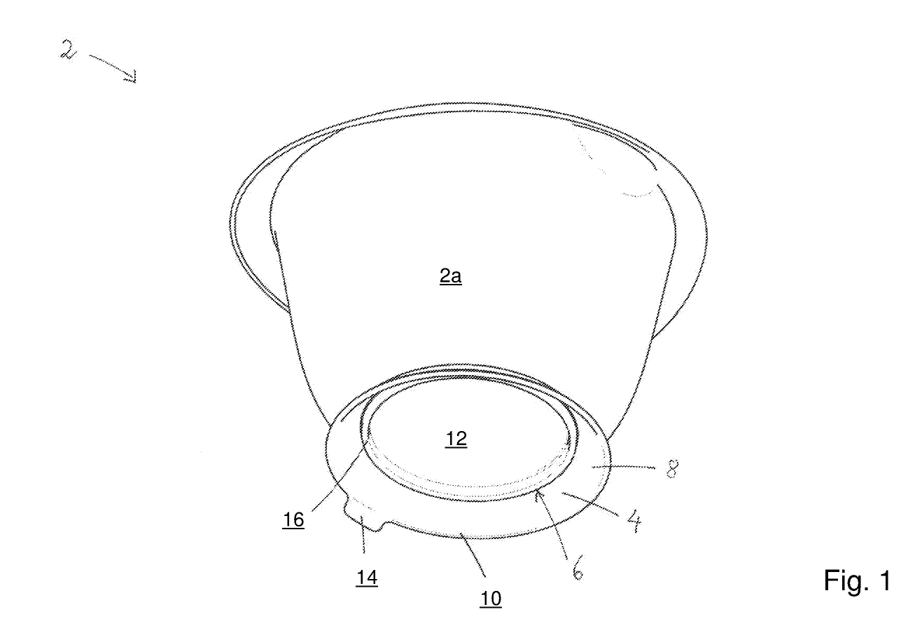

A mixing bowl 2 is shown in a view from obliquely below in FIG. 1. The annular seal 4 which by way of the internal peripheral region thereof is connected in an air-tight manner to the bowl body 2a of the mixing bowl 2 can be readily seen in this view. The annular seal 4 has a movable lip 8 which extends from the peripheral region 6 in the radial direction to the outside. The lip which in the exemplary embodiment is configured as a flat annular seal in the relaxed position shown in FIG. 1 is oriented obliquely downward.

The movable lip on the lower side thereof has an encircling placing face 10 which commences at the external periphery of the movable lip 8 and can be inwardly enlarged depending on the load that acts on the movable lip 8. The placing face 10 in the exemplary embodiment is an annular face.

The peripheral region 6 of the annular seal 4 in the exemplary embodiment is disposed on the external periphery of the bottom side 12 of the mixing bowl 2. On account thereof, the bottom side 12 has a large radius and covers a comparatively large area. Since the annular seal 4 also extends in the lateral direction beyond the face of the bottom side 12 of the mixing bowl 2, the mixing bowl by way of the annular seal 4 is supported across a large area.

When the mixing bowl 2 is placed onto a setup surface 18, the mixing bowl 2 initially bears on the setup surface 18 by way of the external edges of the placing face 10. As the mixing bowl 2 is increasingly stressed, the movable lip 8 bends upward. The placing face 10 of the movable lip 8 herein is enlarged toward the inside until the movable lip 8 by way of the entire radial extent of the latter bears almost horizontally on the setup surface 18. Since the lip 8 in a horizontal position can no longer release restoring forces in an optimal manner because the annular seal 4 by way of the elastic material thereof has almost reached a dead center position, it is advantageous for the dimension by way of which the mixing bowl 2 can be lowered downward in relation to the movable lip 8 to be delimited. For this purpose, a support element 16 which in the exemplary embodiment is configured as an annular web is located on the bottom side 12 of the bowl body 2a of the mixing bowl 2. The support element 16 defines a maximum lowering height of the mixing bowl 2 in relation to the movable lip 8. Air is forced out of the cavity 20 when the mixing bowl 2 is lowered. Since the cavity 20, because of the movable lip 8 and the air-tight adhesion of the latter to the setup surface 18, cannot be filled with fresh air when the mixing bowl 2 is again slightly raised after the contact pressure force has been removed, a vacuum is formed in the cavity 20.

A tension lug 14 by way of which the movable lip can be raised is molded to the movable lip 8. Raising and lifting the movable lip 8 from the setup surface 18 enables the ambient air to flow into the cavity 20 in which a vacuum has been formed after the mixing bowl 2 has been lowered in the direction of the setup surface 18, the vacuum having been maintained by the annular seal 4 and the bearing thereof on the setup surface 18. The movable lip 8 can be readily gripped and lifted by way of the tension lug 14.

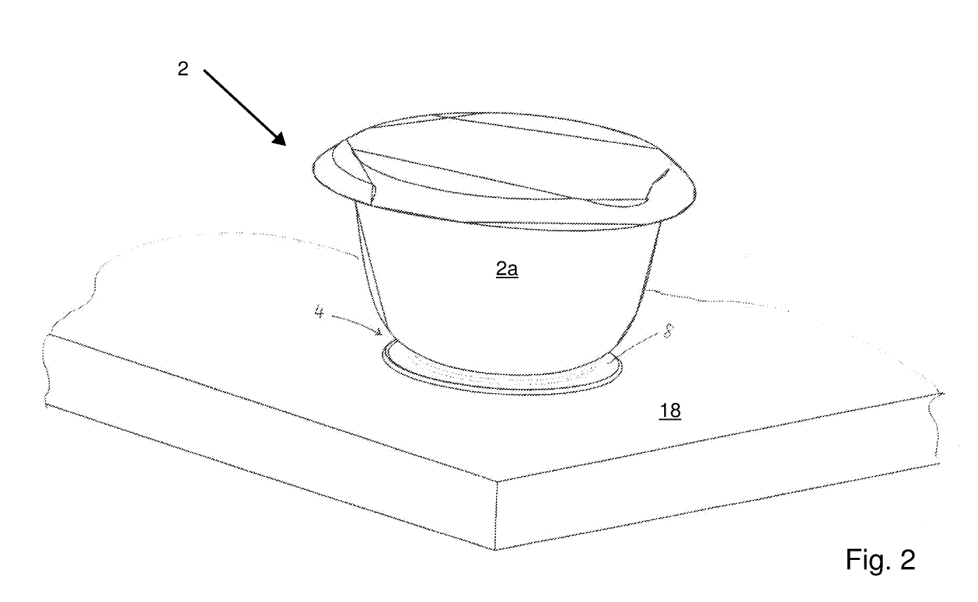

The mixing bowl 2 is shown as placed onto a setup surface 18 in FIG. 2. In the exemplary embodiment the mixing bowl 2 has been pushed down against the movable lip 8 so far that the latter by way of the external periphery thereof is in an almost horizontal position. In order for the mixing bowl 2 to be able to be lowered so far, air which was located in the cavity 20 below the bottom side 12 of the mixing bowl 2 and of the annular seal 4 had to exit to the outside in the lowering movement. In a restoring movement of the mixing bowl 2 that has been initiated by the movable lip 8 and the restoring forces that have been created therein in the lowering movement, a vacuum on account of which the mixing bowl 2 by way of the annular seal 4 is held so as to be pressed onto the setup surface 18 is formed in the cavity 20.

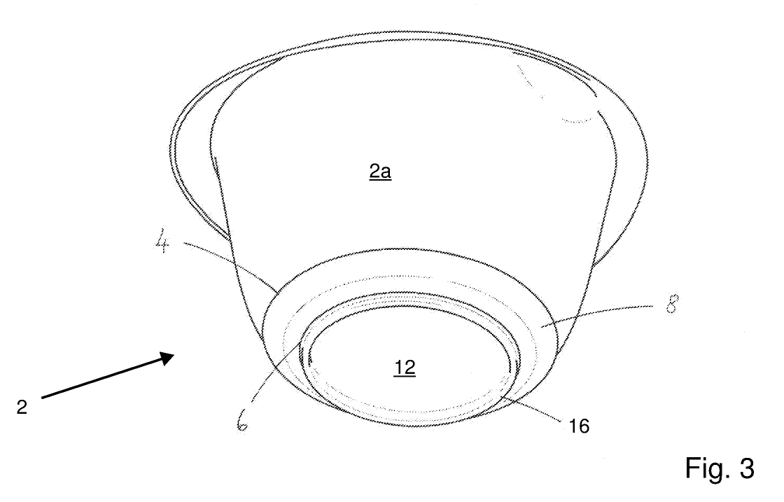

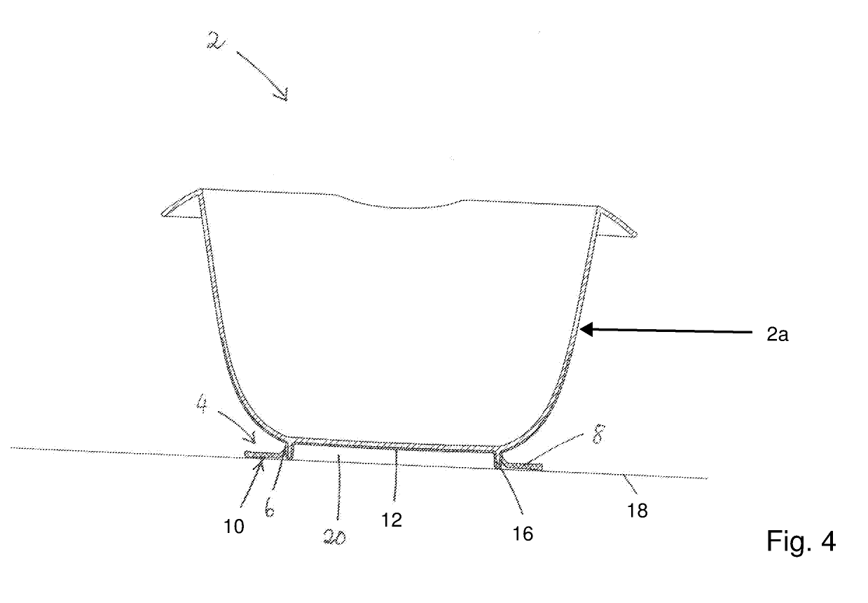

A view of the mixing bowl 2 in which the annular seal 4 is located in a non-use position is shown in FIG. 3. The annular seal 4 in the exemplary embodiment is folded upward in the manner of a collar and bears flat against the exterior surface of the neighboring wall of the bowl body 2a of the mixing bowl 2. When the annular seal 4 is located in the non-use position thereof as shown in FIG. 3, the mixing bowl 2 can thus readily be placed onto a setup surface 18 by way of the support element 16. A sectional view of the mixing bowl having the annular seal is shown in the use position in FIG. 4. The movable lip 8 of the annular seal 4 by way of the placing face 10 bears on the setup surface 18 that is located below the placing face 10. The mixing bowl 12 is lowered downwards so far that the support element 16 is also in contact with the setup surface 18. The cavity 20 which is sealed laterally by the annular support element 16 and the movable lip 8 in relation to the outside against inflowing external air is located between the surface of the setup surface 18 and the bottom side 12 of the mixing bowl.

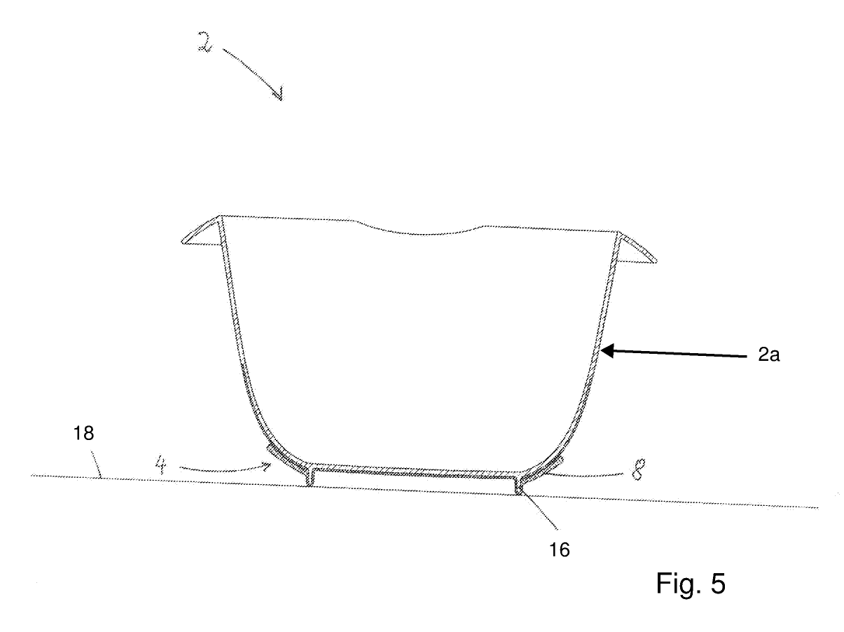

The mixing bowl shown in FIG. 4 is shown in a sectional illustration in FIG. 5, the annular seal 4 being located in the non-use position in the sectional illustration. It can be seen from the sectional view that the movable lip 8 of the annular seal 4 has been placed against the external contour of the side wall of the mixing bowl 2. The mixing bowl 2 in this instance is downwardly supported only by way of the support element 16 on the setup surface 18.

The exemplary embodiment described above serves only for explaining the invention. The invention is not limited to the exemplary embodiment. A person skilled in the art will have no difficulties in modifying the exemplary embodiment in a manner that appears suitable to the person skilled in the art in order for the exemplary embodiment to be adapted to a specific type of application.

The specification incorporates by reference the entire disclosure of European priority document 17 154 468.7 having a priority filing date of Feb. 2, 2017.

While specific embodiments of the invention have been shown and described in detail to illustrate the inventive principles, it will be understood that the invention may be embodied otherwise without departing from such principles.

What is claimed is:

1. A mixing bowl (2) composed of a plastics material, the mixing bowl comprising:
a bowl body (2a) comprising a bottom side (12);
an annular seal (4) composed of an elastic material;
wherein the annular seal (4) comprises a peripheral region (6) that in a radial direction of the annular seal (4) is positioned inwardly and is connected air-tightly to the bottom side (12) of the bowl body (2a);
wherein the annular seal (4) further comprises a lip (8) extending from the peripheral region (6) at least partially in the radial direction outwardly;
wherein the lip (8) is configured to move load-dependently into various positions;
wherein the lip (8) comprises a lower side forming a placing face (10) by which the mixing bowl (2) in at least one position of the lip (8) is supported on a setup surface;
wherein the annular seal (4) and the bottom side (12) of the bowl body (2a) form together a suction cup, wherein the suction cup delimits a cavity (20) that varies in size depending on a position of the lip (8);
wherein the annular seal (4) is configured to be repositioned from a position of use to a non-use position;
wherein the annular seal (4) in the non-use position bears flat against an exterior surface of the bowl body (2a).

2. The mixing bowl (2) according to claim 1, wherein the lip (8) is arranged at the bowl body (2a) at an external periphery of the bottom side (12).

3. The mixing bowl (2) according to claim 1, wherein the lip (8) is configured as a flat annular seal.

4. The mixing bowl (2) according to claim 1, wherein the movable lip (8) comprises a tension lug (14) as an integrally molded part.

5. The mixing bowl (2) according to claim 1, wherein the bottom side (12) of the bowl body (2a) comprises a support element (16) that defines a maximum lowering height of the mixing bowl (2) relative to the lip (8).
